(19) United States
(12) Patent Application Publication
(10) Pub. No.: US 2026/0371080 A1
(43) Pub. Date: Nov. 19, 2026

(54) A METHOD AND APPARATUS FOR REGISTRATION OF A USER EQUIPMENT IN A COMMUNICATION SYSTEM

(71) Applicant: SAMSUNG ELECTRONICS CO., LTD., Suwon-si, Gyeonggi-do (KR)

(72) Inventors: Meghna KHATURIA, Bangalore (IN); Neha SHARMA, Bangalore (IN); Anshuman NIGAM, Bangalore (IN); Dongmyung KIM, Suwon-si (KR); Jinho CHOI, Suwon-si (KR)

(21) Appl. No.: 19/154,755

(22) PCT Filed: Feb. 2, 2024
(86) PCT No.: PCT/KR2024/001617

§ 371 Date: Aug. 7, 2025

(30) Foreign Application Priority Data
Feb. 9, 2023 (IN) 202341008520
Nov. 2, 2023 (IN) 202341008520

(51) Int. Cl. H04W 12/06; H04W 12/72; H04W 60/04

(52) U.S. Cl. CPC H04W 12/06; H04W 12/72; H04W 60/04

(57) ABSTRACT

The disclosure relates to a 5G or 6G communication system for supporting a higher data transmission rate. Disclosed herein is a system (601) and method (500) for registration of a user equipment (UE) (202) with a network. The method is performed by a first network function (204) associated with the network. The method comprises receiving (502) a registration request from the UE. Further, the method comprises sending (504) a UE authentication request to a second network function (206) and simultaneously sending an equipment identity check request to a third network function (208). Further, the method comprises sending (506) one or more additional requests to one or more additional network functions, based on corresponding responses of the UE authentication request and the equipment identity check request. Moreover, the method comprises sending (508), based on corresponding responses to the one or more additional requests, a registration accept message to the UE indicative of a successful registration of the UE (202) with the network.

### TECHNICAL FIELD

Embodiments disclosed herein relate to wireless communication networks, and more particularly to methods and systems for registration of a user equipment with a network.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Technical Problem

The present disclosure relates to wireless communication systems and, more specifically, the present disclosure relates to registration of a user equipment.

### Solution to Problem

This summary is provided to introduce a selection of concepts, in a simplified format, that are further described in the detailed description of the disclosure. This summary is neither intended to identify key or essential inventive concepts of the invention nor is it intended to determine the scope of the disclosure.

Disclosed herein is a method for registration of a user equipment (UE) with a network. The method comprises receiving, by a first network function associated with the network, a registration request from the UE. Further, the method comprises sending, by the first network function, a UE authentication request to a second network function associated with the network and an equipment identity check request to a third network function associated with the network. The UE authentication request and the equipment identity check request are sent simultaneously to the second network function and the third network function respectively. Further, the method comprises sending, by the first network function, one or more additional requests to one or more additional network functions associated with the network, based on corresponding responses of the UE authentication request and the equipment identity check request. Moreover, the method comprises sending, by the first network function based on corresponding responses to the one or more additional requests, a registration accept message to the UE indicative of a successful registration of the UE with the network.

Also disclosed herein is a system for registration of a user equipment (UE) with a network. The system is associated with a first network function. The system comprises a processor and a memory coupled to the processor, wherein the memory comprises executable instructions that, when executed by the processor, cause the system to receive, by the first network function associated with the network, a registration request from the UE; send, by the first network function, a UE authentication request to a second network function associated with the network and an equipment identity check request to a third network function associated with the network, wherein the UE authentication request and the equipment identity check request are sent simultaneously to the second network function and the third network function respectively; send, by the first network function, one or more additional requests to one or more additional network functions associated with the network, based on corresponding responses of the UE authentication request and the equipment identity check request; and send, by the first network function based on corresponding responses to the one or more additional requests, a registration accept message to the UE indicative of a successful registration of the UE with the network.

To further clarify the advantages and features of the present disclosure, a more particular description of the disclosure will be rendered by reference to specific embodiments thereof, which is illustrated in the appended drawing. It is appreciated that these drawings depict only typical embodiments of the disclosure and are therefore not to be considered limiting its scope. The disclosure will be described and explained with additional specificity and detail with the accompanying drawings.

### Advantageous Effects of Invention

According to an embodiment of the disclosure, a wireless communication can be performed efficiently. Especially, a registration of a user equipment can be performed efficiently.

### BRIEF DESCRIPTION OF DRAWINGS

These and other features, aspects, and advantages of the present disclosure will be understood better when the following detailed description is read with reference to the accompanying drawings in which like characters represent like parts throughout the drawings, wherein:

FIG. 1A illustrates a line diagram showing sequential signaling, according to prior arts;

FIG. 1B illustrates the state models at a UE and a network function respectively, according to prior arts;

FIG. 1C illustrates the state models at a UE and a network function respectively, according to prior arts;

FIG. 2 illustrates a process for registration of a user equipment (UE) with a network, in accordance with an embodiment of the present disclosure;

FIG. 3A illustrates a line diagram depicting a process for registration of a user equipment (UE) with a network, in accordance with an embodiment of the present disclosure;

FIG. 3B illustrates a line diagram depicting a process for registration of a user equipment (UE) with a network, in accordance with an embodiment of the present disclosure;

FIG. 3C illustrates a line diagram depicting a process for registration of a user equipment (UE) with a network, in accordance with an embodiment of the present disclosure;

FIG. 4 illustrates a state model associated with the registration management state of the AMF, in accordance with an embodiment of the present disclosure;

FIG. 5A illustrates method flow charts depicting the method for registration of a user equipment (UE) with a network, in accordance with an embodiment of the present disclosure;

FIG. 5B illustrates method flow charts depicting the method for registration of a user equipment (UE) with a network, in accordance with an embodiment of the present disclosure; and

FIG. 6 illustrates an example block diagram of a communication environment depicting a configuration of a network function and a UE, in accordance with an embodiment of the present disclosure.

### MODE FOR THE INVENTION

In recent years, several wireless technologies have been developed to meet the growing number of subscribers for providing better applications and services. The second generation (2G) wireless communication system was developed to provide voice services, while ensuring the mobility of users. The third generation (3G) wireless communication system not only supports voice service but also data service. The fourth generation (4G) wireless communication system has been developed to provide high-speed data service. The fifth generation (5G) wireless communication system has been developed to meet the ever-growing demand for high-speed data services. In addition to mobile broadband services, 5G wireless communication system supports various use-cases ranging from ultra-reliable low latency communications to massive machine type communications.

Generally, the existing 5G system architecture comprises mainly of User Equipment (UEs), Radio Access Network (RAN), i.e., 5G New Radio (NR) and core network (5GC). The 5G core generally comprises a plurality of network functions based on a service-based architecture in addition to application of paradigms such as software defined networking and network function virtualization.

The 5G core network architecture is based on cloud native Service-Based Architecture (SBA). As per TS 23.501, the 5G architecture is defined as service-based and the interaction between network functions is represented in following two ways:
1. A service-based representation, where network functions within the Control Plane enable other authorized network functions to access their services. This representation also includes point-to-point reference points where necessary.
2. A reference point representation shows the interaction that exists between the Network Function (NF) services in the network functions described by a point-to-point reference point between any two network functions.

A list of 5G NFs is as follows: Authentication Server Function (AUSF), Access and Mobility Management Function (AMF), Data Network (DN) (e.g., operator services, Internet access or 3rd party services), Unstructured Data Storage Function (UDSF), Network Exposure Function (NEF), Network Repository Function (NRF), Network Slice Specific Authentication and Authorization Function (NSSAAF), Network Slice Selection Function (NSSF), Policy Control Function (PCF), Session Management Function (SMF), Unified Data Management (UDM), Unified Data Repository (UDR), User Plane Function (UPF), UE radio Capability Management Function (UCMF), Application Function (AF), User Equipment (UE), (Radio) Access Network ((R)AN), 5G-Equipment Identity Register (5G-EIR), Network Data Analytics Function (NWDAF), and Charging Function (CHF).

In 5G service-based core network architecture, any NF node can interact with any other NF node. A set of NFs providing services to other authorized NFs can access their services through Service Based Interface (SBI). Services provided by NFs are essentially capabilities exposed by the NF (for example, NF Service Producer) to other authorized NFs (for example, NF Service Consumer) through a service-based interface. The NF services may support one or more NF service operation(s). The NF may offer different functionalities and thus different NF services. Each of the NF services offered by an NF shall be self-contained, acted upon and managed independently from other NF services offered by the same NF (e.g., for scaling, healing, etc.).

A service-based interface represents how the set of services is provided or exposed by a given NF. This is the interface where the NF service operations are invoked. The service-based interfaces as defined in 3GPP TS 23.501 include Namf, Nsmf, Nudm, Nnrf, Nnssf, Nausf, Nnef, Nsmsf, Nudr, Npcf, N5g-eir, and Nlmf.

With multiple NFs and communication there-between, signaling traffic in the 5G core network has drastically increased. In addition to the inter-NF signaling, there are NF discovery messages that are exchanged between NFs and Network Repository Function (NRF). These messages also add to the signaling congestion in the core network. The increase in signaling traffic in 5G has a negative impact on the completion time of all the procedures, in that signaling latency is increased. Increased services and number of users increase pressure on the core network as the number of messages is increased.

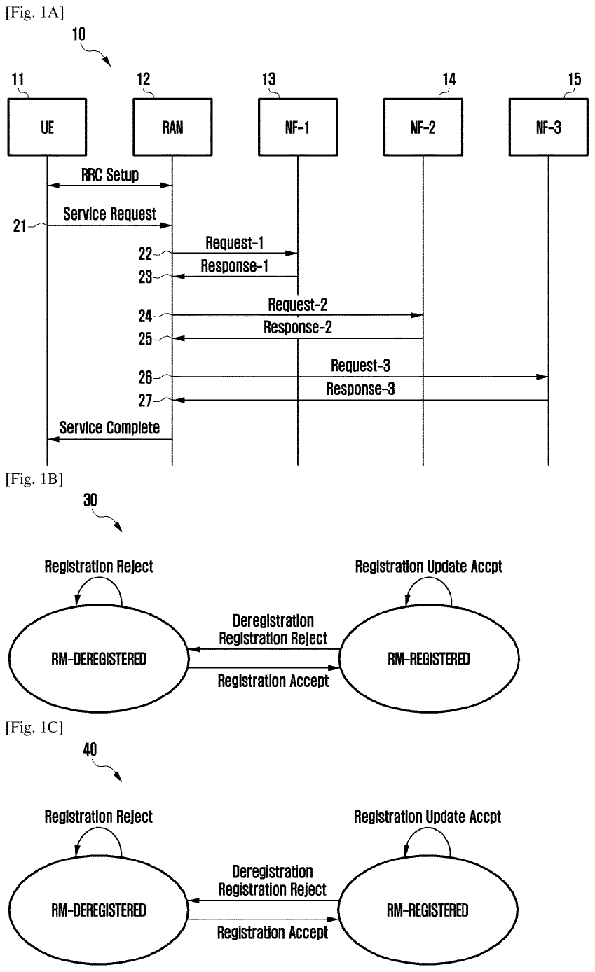

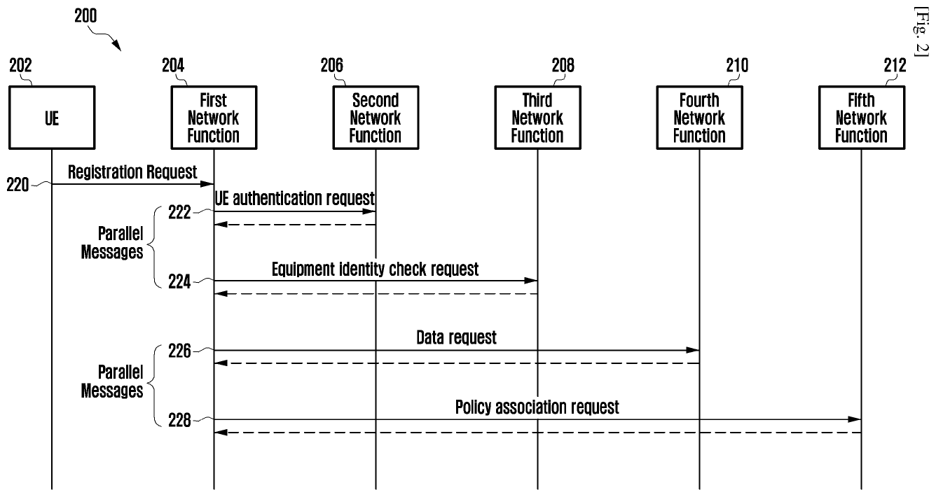

Signaling in the 5G core network is sequential and synchronous, in that, a next request can be sent only after receiving the response of a previous request as there are dependencies between two subsequent requests. Referring to FIG. 1A, a line diagram 10 showing sequential signaling is illustrated according to a conventional technique. As seen in FIG. 1A, in Radio Resource Control (RRC) setup, the UE 11 sends a service request to the Radio Access Network (RAN) 12 in step 21. In step 22, the RAN 12 sends a request 1 to NF-1 13. In step 23, the NF-1 13 sends a response 1 to the RAN 12. After receiving the response 1, the RAN 12 sends a request 2 to NF-2 14 in step 24. In step 25, the NF-2 14 sends a response 2 to the RAN 12. After receiving the response 2, the RAN 12 sends a request 3 to NF-3 15 in step 26. In step 27, the NF-3 15 sends a response 3 to the RAN 12.

The sequential mechanism is inefficient as it increases the completion time of the procedure as requests are processed in a sequential manner. The sequential message exchange also leads to inefficient usage of resources. Synchronous integration (HTTP request/response) of NFs leads to tightly coupled systems. This increases the overall messages and failure management also becomes complex. With the advent of 6G networks, there will be multiple applications and heterogeneous devices which will perform signaling with the core network. In such a scenario, hierarchical and sequential procedure may lead to increased latencies.

Further, with sequential signaling, the UE and a network function (for example, AMF) maintain respective state models to represent the corresponding registration states. FIGS. 1B and 1C illustrate the state models 30, 40 at the UE and the network function respectively. As seen in FIGS. 1B-1C, two Registration Management (RM) states are used in the UE and the AMF that reflect the registration status of the UE.

In the RM-DEREGISTERED state, the UE is not registered with the network. UE context in the network function holds no valid location or routing information for the UE so the UE is not reachable by the network function. However, some parts of the UE context may still be stored in the UE and the network function to avoid running an authentication procedure during every registration procedure. In the RM-DEREGISTERED state, the UE attempts to register with a selected Public Land Mobile Network (PLMN) using an Initial Registration procedure to get service from the network. The UE remains in RM-DEREGISTERED state if a Registration Reject is received upon Initial Registration. The UE may enter RM-REGISTERED state upon receiving a Registration Accept.

In the RM-REGISTERED state, the UE is registered with the network and can receive services that require registration with the network. The UE may perform Mobility Registration Update procedure to maintain the registration and enable the network function to page the UE; to update capability information, or to re-negotiate protocol parameters. A Periodic Registration Update procedure may be triggered by an expiration of the periodic update timer. Further, deregistration procedure may be performed, and the UE may enter RM-DEREGISTERED state. Furthermore, the UE may move to the RM-DEREGISTERED state when a Registration Reject message or a Deregistration message is received.

As depicted, there are two states (RM-REGISTERED and RM-DEREGISTERED) that are maintained as the registration procedure is sequential in nature. Moreover, the state is changed when the entire procedure is completed. With a change from sequential signaling, a change in state model is also required to accurately monitor the various states.

Thus, it is desired to address the above-mentioned disadvantages or other shortcomings or at least provide a useful alternative to overcome the above-mentioned disadvantages associated with signaling associated the registration of UE with a network.

For the purpose of promoting an understanding of the principles of the disclosure, reference will now be made to the various embodiments and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

The term “some” or “one or more” as used herein is defined as “one”, “more than one”, or “all.” Accordingly, the terms “more than one,” “one or more” or “all” would all fall under the definition of “some” or “one or more”. The terms “an embodiment”, “another embodiment”, “some embodiments”, or “in one or more embodiments” may refer to one embodiment, several embodiments, or all embodiments. Accordingly, the term “some embodiments” is defined as meaning “one embodiment, or more than one embodiment, or all embodiments.”

The terminology and structure employed herein are for describing, teaching, and illuminating some embodiments and their specific features and elements and do not limit, restrict, or reduce the spirit and scope of the claims or their equivalents. The phrase “exemplary” may refer to an example.

More specifically, any terms used herein such as but not limited to “includes,” “comprises,” “consisting,” “has,” and “have” and grammatical variants thereof do not specify an exact limitation or restriction and certainly do not exclude the possible addition of one or more features or elements, unless otherwise stated, and must not be taken to exclude the possible removal of one or more of the listed features and elements unless otherwise stated with the limiting language “mush comprise” or “needs to include”.

Whether or not a certain feature or element was limited to being used only once, either way, it may still be referred to as “one or more features”, “one or more elements”, “at least one feature”, or “at least one element.” Furthermore, the use of the terms “one or more” or “at least one” feature or element does not preclude there being none of that feature or element unless otherwise specified by limiting language such as “there needs to be one or more” or “one or more element is required.”

Unless otherwise defined, all terms, and especially any technical and/or scientific terms, used herein may be taken to have the same meaning as commonly understood by one having ordinary skill in the art.

Now embodiments of the present disclosure will be described below in detail with reference to the accompanying drawings.

A core network is an essential component within a network environment in which various network functions act to provide connectivity and services. The core network may include multiple network functions which may communicate via corresponding interfaces to provide a service-based architecture. Each of the plurality of network functions may be configured to perform a specific task to ensure proper operation and management of the network. The plurality of network functions may be configured to perform routing of data packets, switching functions, load balancing, Network Address Translation (NAT) functions, Domain Name Systems (DNS) functions, Quality of Service (QoS) functions, packet inspections, authentication and authorization, encryption and decryption, and the like.

In non-limiting examples, the plurality of network functions may include:
AMF (Access and Mobility Management Function) configured to perform device registration and authentication, mobility management, and session management.
PCF (Policy Control Function) configured to enforce policies related to Quality of Service (QoS) and network resource allocation.
EIR (Equipment Identity Register) configured to function as a database that stores information related to the identity of mobile equipment.
SMF (Session Management Function) configured for session establishment and management.
UPF (User Plane Function) configured to handle user data traffic and data routing.
AUSF (Authentication Server Function) configured to provide authentication and security services for user equipment.
UDM (Unified Data Management) configured to manage and store user-related data and profiles such as subscription data and authentication credentials.

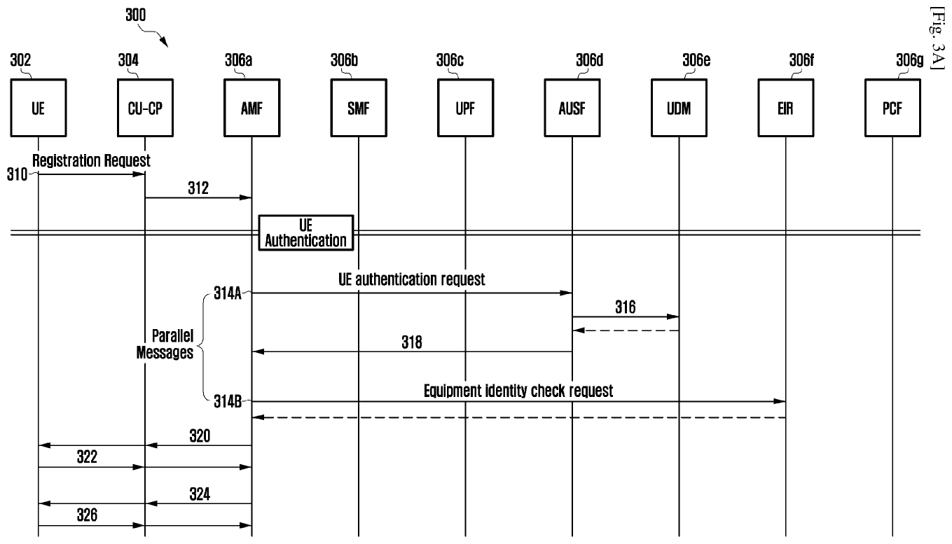

FIG. 2 illustrates a process 200 for registration of a user equipment (UE) 202 with a network. The network may be associated with a plurality of network functions, including, a first network function 204, a second network function 206, a third network function 208, a fourth network function 210, and a fifth network function 212. In an embodiment, the network may be a 5G network. In another embodiment, the network may be a 6G network.

Initially, at step 220, the UE may send a registration request to the first network function. The registration request may be a Non-Access Stratum (NAS) registration request. The registration request may be received by the first network function. The registration request may include at least a subscriber identifier value and a user equipment identifier value. In an embodiment, the subscriber identifier value may include at least one of a Subscription Concealed Identifier (SUCI), a Subscription Permanent Identifier (SUPI), or a Global Unique Temporary Identifier (GUTI).

In an embodiment, the user equipment identifier value may include at least a Permanent Equipment Identifier (PEI) associated with the UE. In an embodiment, the registration request may include the PEI as the user equipment identifier value based on a type of the registration request. The registration request received by the first network function may be one of a periodic registration request, a mobility registration request, an initial registration request, or an emergency registration request. In the embodiment when the registration request is the initial registration request, the registration request may include the PEI associated with the UE.

At step 222, the first network function may send a UE authentication request to the second network function. Simultaneously, at step 224, the first network function may send an equipment identity check request to the third network function. That is, parallel messaging may be enabled in which the first network function parallelly sends requests to other network functions, i.e., the UE authentication request to the second network function and the equipment identity check request to the third network function. In an embodiment, the PEI may be available at the first network function prior to receiving the registration request from the UE, and further, the equipment identity check request sent to the third network function may include the PEI.

The first network function receives the corresponding responses of the UE authentication request and the equipment identity check request from the second network function and the third network function respectively. Upon receiving the corresponding responses, one or more additional requests may be sent by the first network function to one or more additional network functions upon receiving the corresponding responses. As depicted, in step 226, a data request may be sent by the first network function to the fourth network function and in step 228, a policy association request may be sent by the first network function to the fifth network function. The data request and the policy association request may be sent simultaneously by the first network function.

In an embodiment, first network function is an Access and Mobility Management Function (AMF), the second network function is an Authentication Server Function (AUSF), the third network function is an Equipment Identity Register (EIR) of the network, the fourth network function is a Unified Data Management (UDM), and the fifth network function is a Policy Control Function (PCF).

In an embodiment, the first network function may be configured to maintain a registration management state via a state model which reflects the registration state of the UE 302. The registration management state may be maintained based on the UE authentication request, the equipment identity check request, the data request, and the policy association request. The first network function may be configured to receive the corresponding responses for the equipment identity check request, the data request, and the policy association request. Further, the first network function may be configured to dynamically update the registration management state based on the received corresponding responses, thereby ensuring proper flow of messages and signals.

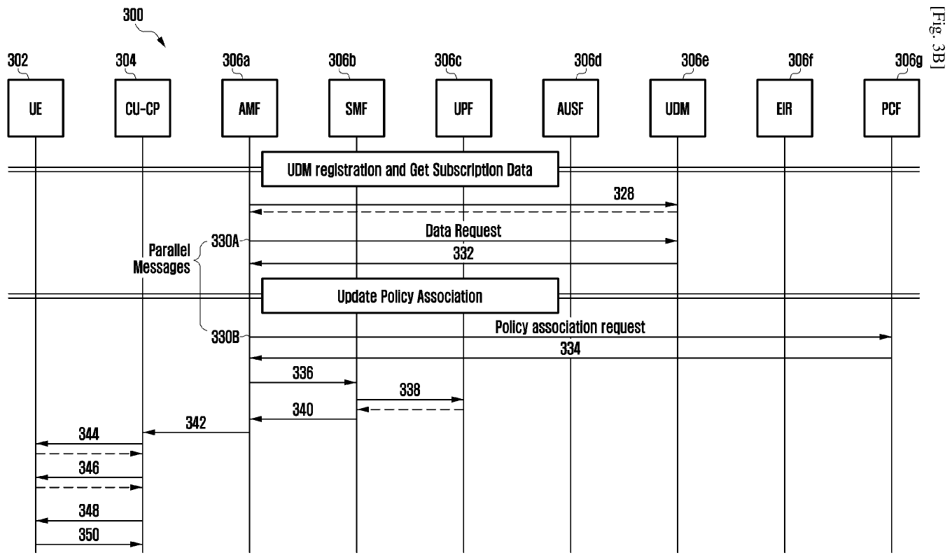

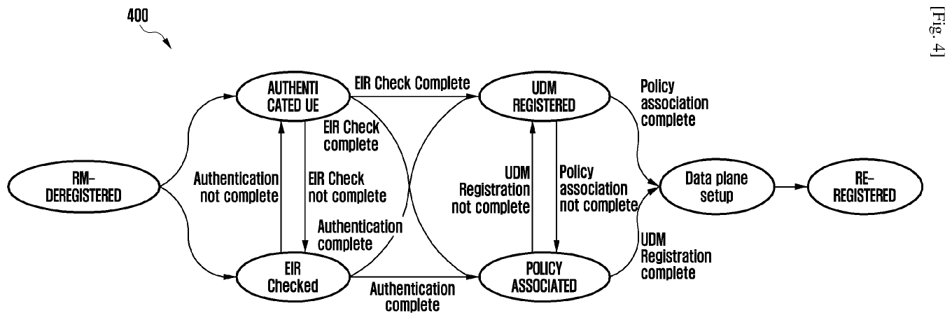

Reference is now made to FIG. 3A-3B which illustrate a line diagram 300 depicting a process for registration of a UE with a network, in accordance with an embodiment of the present invention. FIG. 3B may be considered a continuation of FIG. 3A. The network may include the UE 302, a Central Unit-Control Plane (CU-CP) 304, and a plurality of network functions, namely, AMF 306a, SMF 306b, UPF 306c, AUSF 306d, UDM 306e, EIR 306f, and PCF 306g.

At step 310, the UE 302 may send a registration request to the CU-CP 304. The registration request includes parameters such as, but not limited to, registration type, SUCI or 5G-GUTI or PEI, last visited Tracking Area Identity (TAI), security parameters, requested Network Slice Selection Assistance Information (NSSAI), default configured NSSAI indication, UE radio capability update, UE MM core network capability, PDU session status, list of PDU sessions to be activated, etc. At step 312, the CU-CP 304 may send the registration request to the AMF 306a.

The AMF 306a receives the registration request and proceeds with the process of UE authentication. The UE authentication may be performed to determine whether the UE is legitimate and authorized for services. At step 314A, the AMF 306a sends a UE authentication request to the AUSF 306d. The AUSF 306d may be selected by the AMF 306a based on SUPI or SUCI. The UE authentication request may be a Nausf_UEAuthenticate_authenticate Request.

At step 316, the AUSF 306d obtains authentication information from the UDM 306e. The AUSF 306d may send a Nudm_UEAuthenticate_Get Request to the UDM 306e and receive the corresponding response from the UDM 306e.

At step 318, the AUSF 306d sends the obtained information to the AMF 306a. The obtained information may be indicative of the authentication result. The obtained information may be associated with the SUPI of the UE. The AUSF 306d may send the obtained information in a Nausf_UEAuthenticate_authenticate Response.

Parallel to step 314A, at step 314B, the AMF 306a may send the equipment identity check request to the EIR 306f. The EIR 306f may maintain information regarding whether the UE is blacklisted or whitelisted. The EIR 306f may be a database containing the information regarding the UE which may be correlated to the PEI associated with the UE. The EIR 306f may be accessed using the PEI, and the equipment identity check request may include the PEI. The equipment identity check request may be a N5g-eir_EquipmenIdentityCheck Request. In an embodiment, the equipment identity check request sent at step 314B does not depend on the response of the UE authentication request. In an embodiment, the equipment identity check request may include the SUPI.

The steps 314A and 314B may thus be performed in parallel. The AMF 306a may then receive the response to the equipment identity check request from the EIR 306f. At step 320, the AMF 306a sends the NAS authentication request to the CU-CP 304 which sends the NAS authentication request to the UE 302. At step 322, the UE 302 sends the NAS authentication response to the CU-CP 304 which sends the NAS authentication response to the AMF 306a. At step 324, the AMF 306a sends the NAS security mode command to the CU-CP 304 which sends the NAS security mode command to the UE 302. At step 326, the UE 302 sends the NAS security mode complete signal to the CU-CP 304 which sends the NAS security mode complete signal to the AMF 306a. The NAS security mode command may be indicative of a security algorithm to be performed by the UE 302.

The AMF 306a may then proceed with UDM registration and policy association updates. At step 328, the AMF 306a sends a request to register with the UDM 306e and receives a response from the UDM 306e. The request may be a Nudm_UEContextManagement_Registration Request.

At step 330A, the AMF 306a sends a data request to the UDM 306e. The data requested may include access and mobility data, SMF selection subscription data, and UE context in SMF data. The data request may be a Nudm_SubscriberDataManagement_GetRequest. At step 332, the AMF 306a may receive the requested data from the UDM 306e after the UDM 306e receives the data request.

Parallel to step 330A, at step 330B, the AMF 306a sends a policy association request to the PCF 306g. The policy association request may be a Npcf_AMPolicyControl_Create Request. The policy association request may be sent to create policy association and retrieve UE policy and/or Access and Mobility control policy. The policy association request may include input parameters such as SUPI, Generic Public Subscription Identifier (GPSI), AccessType, PEI, UserLocation, etc. The policy association request may include input parameters which may not depend on the data received from the UDM 306e in step 332. Accordingly, the steps 330A and 330B may be sent in parallel. At step 334, the PCF 306g sends a response with policy association information.

At step 336, the AMF 306a communicates with the SMF 306b to activate a list of PDU sessions, which may be received as part of the registration request. The communication between the AMF 306a and the SMF 306b may be via a Nsmf_PDUSession_UpdateSMContext Request. At step 338, the SMF 306b sends a session modification request to the UPF 306c and receives a corresponding response. The SMF 306b may assign an IP address to the UE 302, set up a General Packet Radio Service (GPRS) Tunnelling Protocol (GTP) tunnel ID for uplink sessions, and configure the UPF 306c to set up the data plane. At step 340, the SMF 306b informs the AMF 306a that the session management context has been updated. The SMF 306b may communicate with the AMF 306a via a Nsmf_PDUSession_UpdateSMContext Response.

At step 342, the AMF 306a may initiate a session setup with the CU-CP 304 and send a NAS message for the UE indicative of acceptance of registration. At step 344, before sending the registration accept signal to the UE 302, the CU-CP 304 may set up radio security using Security Mode Command/Complete messages. At step 346, the CU-CP 304 may enquire UE capabilities from the UE 302. The CU-CP 304 may send the UE capabilities to the AMF 306a. At step 348, the CU-CP 304 may send a Radio Resource Control (RRC) reconfiguration command to the UE 302 to set up the Data Radio Bearers (DRBs) which may also contain registration accept message. At step 350, the UE 302 may send RRC reconfiguration complete message to the CU-CP 304, and further to the AMF 306a, along with a Registration Complete NAS message which indicates successful completion of Registration Procedure.

In an embodiment, in order to perform the steps 314A and 314B in parallel, the PEI associated with the UE is available at the AMF 306a. In some embodiments, both SUCI/5G-GUTI and PEI are available with AMF 306a in order to perform the steps 314A and 314B in parallel. In some embodiments, the registration request sent by the UE 302 in step 310 includes mobile identity associated with the UE 302. The registration request includes a 5GS mobile identity field which may be modified to include one or more of: (a) SUCI and PEI or (b) 5G-GUTI and PEI. Tables 1-2 below depict the modified 5GS identity type field in the registration request, as per the present disclosure.

TABLE 1

5GS mobile identity Type IE
Length of 5GS mobile identity contents
5G-GUTI
IMEI

TABLE 2

| 4 | 3 | 2 | 1 | |
|---|---|---|---|---|
| 0 | 0 | 0 | 1 | SUCI |
| 0 | 0 | 1 | 0 | 5G-GUTI |
| 0 | 0 | 1 | 1 | IMEI |
| 0 | 1 | 0 | 0 | SG-S TMSI |
| 0 | 1 | 0 | 1 | IMEISV |
| 0 | 1 | 1 | 0 | MAC Address |
| 0 | 1 | 1 | 1 | EUI-64 |
| 1 | 0 | 0 | 1 | SUCI and PEI |
| 1 | 0 | 1 | 0 | 5G-GUTI and PEI |

The AMF 306a is further configured to ensure proper flow of signals and messages by means of tracking the states associated with the UE. The AMF 306a may be associated with a state model for a registration management state of the AMF 306a that reflects the registration status of the UE 302. In contrast to having only the RM-REGISTERED and RM-DEREGISTERED states, the state model associated with the AMF 306a comprises multiple other states for the proper flow of messages.

FIG. 4 illustrates a state model 400 associated with the registration management state of the AMF 306a, in accordance with an embodiment of the present disclosure. The registration management states may include RM-DERIGESTERED, AUTHENTICATED UE, EIR CHECKED, UDM REGISTERED, POLICY ASSOCIATED, DATA PLANE SETUP, and RM-REGISTERED. The details associated with the registration management states are provided further below.

In the RM-DEREGISTERED state, the UE 302 is not registered with the network and cannot receive any services. When the UE is in RM-DEREGISTERED state and initiates the registration procedure as detailed above with respect to FIGS. 2-3, the state may be update to either the AUTHENTICATED UE state or the EIR CHECKED state based on corresponding responses of the UE authentication request and the equipment identity check request sent parallelly at steps 314A and 314B.

If the UE authentication (response to UE authentication request sent at step 314A) is complete before EIR check (response to equipment identity check request sent at step 314B), the AMF 306a may transition to the AUTHENTICATED UE state. In the AUTHENTICATED UE state, the AMF 306a may transition to the EIR CHECKED state if the EIR check is not completed. If EIR check is complete, then AMF may transition to either the UDM REGISTERED or the POLICY ASSOCIATED state based on responses to the data request and policy association request sent parallelly at steps 330A and 330B.

When the UE is in RM-DEREGISTERED state and the EIR check (response to equipment identity check request sent at step 314B) is complete before UE authentication (response to UE authentication request sent at step 314A), the AMF 306a may transition to the EIR CHECKED state. In the EIR CHECKED state, the AMF 306a may transition to the AUTHENTICATED UE state if the UE authentication is not complete. If UE authentication is complete, then AMF 306a may transition to either the UDM REGISTERED or the POLICY ASSOCIATED state based on responses to the data request and policy association request sent parallelly at steps 330A and 330B.

When EIR check and UE Authentication are complete, the AMF 306a may move to UDM REGISTERED state if UDM registration (response to data request sent at step 330A) is complete before policy association (response to policy association request sent at step 330B). In the UDM REGISTERED state, the AMF 306a may wait for policy association to be completed. Once policy association is completed, the AMF 306a may move to the POLICY ASSOCIATED state. If the policy association is already complete, then AMF 306a may move to DATA PLANE SETUP state and initiate data plane setup.

When EIR check and UE Authentication are complete, the AMF 306a may move to POLICY ASSOCIATED state if the policy association (response to policy association request sent at step 330B) is completed before UDM registration (response to data request sent at step 330A). In the POLICY ASSOCIATED state, the AMF 306a may wait for the UDM registration to complete. Once UDM registration is completed, the AMF 306a may move to UDM REGISTERED state. If the UDM registration is already complete, then AMF 306a may initiate data plane setup and move to the DATA PLANE SETUP state.

In the DATA PLANE SETUP state, upon receiving data plane set up request from the AMF 306a, the SMF 306b may set up the GTP tunnel and configure the UPF 306c to set up the data plane. After successfully setting up the data plane, the SMF 306b may inform the session information to the AMF 306a, as described above with reference to steps 338-340.

In the RM-REGISTERED state, the UE 302 is registered with the network and the UE can receive services that require registration with the network.

In some embodiments, the registration request received by the AMF 306a may be one of a periodic registration request, a mobility registration request, an initial registration request, and an emergency registration request. The type of registration request may indicate whether the UE 302 wants to perform the initial registration (i.e., the UE 302 is in RM-DEREGISTERED state), the mobility registration update (i.e., the UE 302 is in RM-REGISTERED state and initiates a Registration procedure due to mobility), a periodic registration update (i.e., the UE 302 is in RM-REGISTERED state and initiates a registration procedure due to a periodic registration update timer expiry), and an emergency registration (i.e., the UE is in limited service state).

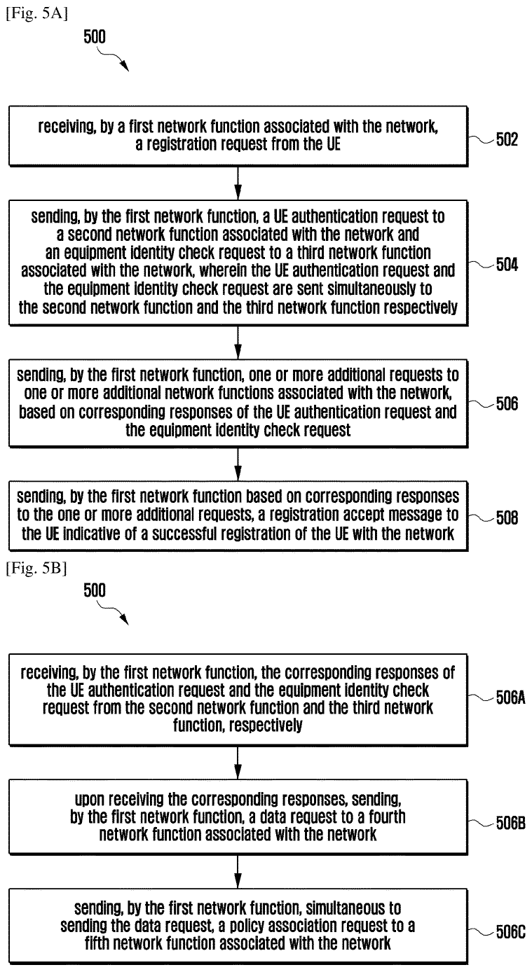

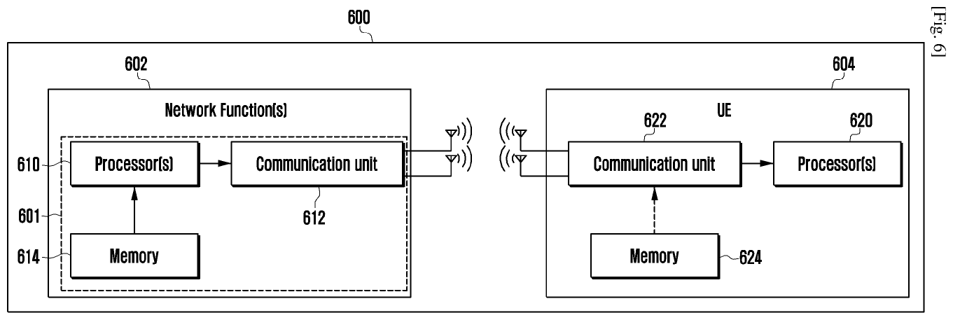

FIG. 5A illustrates a method flow chart depicting a method 500 for registration of a user equipment (UE) with a network, in accordance with an example embodiment of the present disclosure.

The method shown in FIG. 5A begins at block 502. At block 502, the method 500 comprises receiving, by a first network function associated with the network, a registration request from the UE. In an embodiment, the first network function is an Access and Mobility Management Function (AMF).

At block 504, the method 500 comprises sending, by the first network function, a UE authentication request to a second network function associated with the network and an equipment identity check request to a third network function associated with the network. The UE authentication request and the equipment identity check request are sent simultaneously to the second network function (206) and the third network function (208) respectively. In an embodiment, the second network function is an Authentication Server Function (AUSF), and the third network function is an Equipment Identity Register (EIR) of the network.

At block 506, the method 500 comprises sending, by the first network function, one or more additional requests to one or more additional network functions associated with the network, based on corresponding responses of the UE authentication request and the equipment identity check request. In some embodiments, to send the one or more additional requests, the method 500 comprises steps 506A-506C as depicted in FIG. 5B. At step 506A, the method 500 comprises receiving, by the first network function, the corresponding responses of the UE authentication request and the equipment identity check request from the second network function and the third network function, respectively. At step 506B, the method 500 comprises sending, by the first network function, a data request to a fourth network function associated with the network upon receiving the corresponding responses. At step 506C, the method 500 comprises sending, by the first network function, simultaneous to sending the data request, a policy association request to a fifth network function associated with the network. In an embodiment, the fourth network function is a Unified Data Management (UDM) and the fifth network function is a Policy Control Function (PCF).

At block 508, the method 500 comprises sending, by the first network function based on corresponding responses to the one or more additional requests, a registration accept message to the UE indicative of a successful registration of the UE with the network.

While the above discussed steps in FIGS. 5A-5B are shown and described in a particular sequence, the steps may occur in variations to the sequence in accordance with various embodiments. Further, a detailed description related to the various steps of FIGS. 5A-5B is already covered in the description related to FIGS. 2-4 and is omitted herein for the sake of brevity.

FIG. 6 illustrates an example block diagram of a communication environment 600 depicting a configuration of a network function(s) 602 and a user equipment 604, according to one or more embodiments disclosed herein. The configurations as disclosed in FIG. 6 may be understood as parts of the configuration of the network function 602 and the user equipment 604. Hereinafter, it is understood that terms including “unit” or “module” at the end may refer to the unit for processing at least one function or operation and may be implemented in hardware, software, or a combination of hardware and software.

Referring to FIG. 6, the network function 602 may include one or more processor(s) 610 (also, referred to as processor 610), a communication unit 612 (e.g., communicator or communication interface), and a storage unit (e.g., memory 614). By way of example, the network function 602 may correspond to at least one the first network function, the second network function, the third network function, the fourth network function, the fifth network function as described above with reference to FIG. 2 and/or at least one of the AMF, SMF, UPF, AUSF, UDM, EIR, PCF, and any other types of network function as described above with reference to FIG. 3A-3B. The communication unit 612 may perform functions for transmitting and receiving signals. In an embodiment, the network function 602 may be associated with a system 601 comprising at least the processor 610 and the memory 614. The memory 614 may include executable instructions that, when executed by the processor, cause the system to perform the steps as described above with reference to FIGS. 2-3 and 5A-5B. Further, the system 601 may be in communication with the network function(s) 602, such as the first network function, the second network function, the third network function, the fourth network function, the fifth network function as described above with reference to FIG. 2 and/or at least one of the AMF, SMF, UPF, AUSF, UDM, EIR, PCF, and any other types of network function as described above with reference to FIG. 3A-3B to perform the steps as described above with reference to FIGS. 2-3 and 5A-5B.

As an example, the processor 610 may be a single processing unit or a number of units, all of which could include multiple computing units. The processor 610 may be implemented as one or more microprocessors, microcomputers, microcontrollers, digital signal processors, central processing units, state machines, logic circuitries, and/or any devices that manipulate signals based on operational instructions. Among other capabilities, the processor 610 is configured to fetch and execute computer-readable instructions and data stored in the memory. The processor 610 may include one or a plurality of processors. At this time, one or a plurality of processors 610 may be a general-purpose processor, such as a central processing unit (CPU), an application processor (AP), or the like, and an AI-dedicated processor such as a neural processing unit (NPU). The processor 610 may control the processing of input data in accordance with a predefined operating rule or artificial intelligence (AI) model stored in the non-volatile memory and the volatile memory, i.e., the memory 614. The predefined operating rule or artificial intelligence model is provided through training or learning.

The memory 614 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes.

In some embodiments, the network function 602 may be implemented as dedicated hardware units. In some embodiments, the network function 602 may be implemented in the form of virtualized software units in hardware or cloud environments.

Further, the user equipment 604 may also include one or more processor(s) 620 (also, referred to as processor 620), a communication unit 622 (e.g., communicator or communication interface), and a storage unit (e.g., memory 624). The communication unit 622 may perform functions for transmitting and receiving signals. The functionalities and features of the processor 620, communication unit 622, and memory 624 may be similar to those of the processor 610, communication unit 612, and memory 614, respectively. Therefore, a detailed explanation of the same is omitted herein for the sake of brevity of the present disclosure.

The method disclosed herein provides various technical advantages and benefits such as a reduction in signaling latency for procedures, such as the registration process of UE with the network. Signaling between the network functions is also efficient by virtue of the parallel signaling among the network functions. Further, with parallel mechanism (asynchronous system) in the network signaling as described in the present disclosure, the completion time of procedures is reduced. Moreover, the asynchronous system further leads to reduction in signaling latency by processing requests in parallel and improving resource utilization. The parallel mechanism is further enabled with the described changes in the state model (as described with reference to FIG. 4) and 5GS identity type in registration requests.

The embodiments disclosed herein can be implemented through at least one software program running on at least one hardware device and performing network management functions to control the elements. The elements can be at least one of a hardware device, or a combination of hardware device and software module.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

1. A method (500) for registration of a user equipment (UE) with a network, the method (500) comprising:
receiving (502), by a first network function (204) associated with the network, a registration request from the UE (202);
sending (504), by the first network function (204), a UE authentication request to a second network function (206) associated with the network and an equipment identity check request to a third network function (208) associated with the network, wherein the UE authentication request and the equipment identity check request are sent simultaneously to the second network function (206) and the third network function (208) respectively;
sending (506), by the first network function (204), one or more additional requests to one or more additional network functions associated with the network, based on corresponding responses of the UE authentication request and the equipment identity check request; and
sending (508), by the first network function (204) based on corresponding responses to the one or more additional requests, a registration accept message to the UE (202) indicative of a successful registration of the UE (202) with the network.

2. The method (500) of claim 1, wherein sending the one or more additional requests to the one or more additional network functions comprises:
receiving (506A), by the first network function (204), the corresponding responses of the UE authentication request and the equipment identity check request from the second network function (206) and the third network function (208), respectively;
upon receiving the corresponding responses, sending (506B), by the first network function (204), a data request to a fourth network function (210) associated with the network; and
sending (506C), by the first network function (204), simultaneous to sending the data request, a policy association request to a fifth network function (212) associated with the network.

3. The method (500) of claim 1, wherein the first network function (204) is an Access and Mobility Management Function (AMF), the second network function (206) is an Authentication Server Function (AUSF), and the third network function (208) is an Equipment Identity Register (EIR) of the network.

4. The method (500) of claim 2, comprising:
maintaining, by the first network function (204), a registration management state based on the UE authentication request, the equipment identity check request, the data request, and the policy association request;
receiving, by the first network function (204), corresponding responses to the UE authentication request, the equipment identity check request, the data request, and the policy association request; and
dynamically updating the registration management state based on the received corresponding responses,
wherein the fourth network function (210) is a Unified Data Management (UDM) and the fifth network function (212) is a Policy Control Function (PCF).

5. The method (500) of claim 1, wherein the registration request includes at least a subscriber identifier value and a user equipment identifier value, and wherein the subscriber identifier value includes at least one of a Subscription Concealed Identifier (SUCI), Subscription Permanent Identifier (SUPI), or a Global Unique Temporary Identifier (GUTI).

6. The method (500) of claim 4, wherein the user equipment identifier value includes at least a Permanent Equipment Identifier (PEI).

7. The method (500) of claim 1, wherein:
the equipment identity check request includes a Permanent Equipment Identifier (PEI) associated with the UE (202), and
the PEI is available at the first network function prior to receiving the registration request from the UE (202).

8. The method (500) of claim 1, wherein:
the registration request is one of a periodic registration request, a mobility registration request, an initial registration request, and an emergency registration request, and
when the registration request is the initial registration request, the registration request includes a Permanent Equipment Identifier (PEI) associated with the UE (202).

9. A system (601) for registration of a user equipment (UE) (202) with a network, the system (601) being associated with a first network function (204), the system (601) comprising:
a processor (610);
a memory (614) coupled to the processor, wherein the memory (614) comprises executable instructions that, when executed by the processor (610), cause the system (601) to:
receive, by the first network function (204) associated with the network, a registration request from the UE (202);
send, by the first network function (204), a UE authentication request to a second network function (206) associated with the network and an equipment identity check request to a third network function (208) associated with the network, wherein the UE authentication request and the equipment identity check request are sent simultaneously to the second network function (206) and the third network function (208) respectively;
send, by the first network function (204), one or more additional requests to one or more additional network functions associated with the network, based on corresponding responses of the UE authentication request and the equipment identity check request; and
send, by the first network function (204) based on corresponding responses to the one or more additional requests, a registration accept message to the UE (202) indicative of a successful registration of the UE (202) with the network.

10. The system (601) of claim 9, wherein to send the one or more additional requests to the one or more additional network functions, the executable instructions when executed by the processor (610) cause the system (601) to:
receive, by the first network function (204), the corresponding responses of the UE authentication request and the equipment identity check request from the second network function (206) and the third network function (208), respectively;
upon receiving the corresponding responses, send, by the first network function (204), a data request to a fourth network function (210) associated with the network; and
send, by the first network function (204), simultaneous to sending the data request, a policy association request to a fifth network function (212) associated with the network.

11. The system (601) of claim 9, wherein the first network function (204) is an Access and Mobility Management Function (AMF), the second network function (206) is an Authentication Server Function (AUSF), and the third network function (208) is an Equipment Identity Register (EIR) of the network.

12. The system (601) of claim 9, wherein the executable instructions when executed by the processor (610) cause the system (601) to:
maintain, by the first network function (204), a registration management state based on the UE authentication request, the equipment identity check request, the data request, and the policy association request;
receive, by the first network function (204), corresponding responses to the UE authentication request, the equipment identity check request, the data request, and the policy association request; and
dynamically update the registration management state based on the received corresponding responses, wherein the fourth network function (210) is a Unified Data Management (UDM) and the fifth network function (212) is a Policy Control Function (PCF).

13. The system (601) of claim 9, wherein the registration request includes at least a subscriber identifier value and a user equipment identifier value, and wherein the subscriber identifier value includes at least one of a Subscription Concealed Identifier (SUCI), Subscription Permanent Identifier (SUPI), or a Global Unique Temporary Identifier (GUTI), and wherein the user equipment identifier value includes at least a Permanent Equipment Identifier (PEI).

14. The system (601) of claim 9, wherein:
the equipment identity check request includes a Permanent Equipment Identifier (PEI) associated with the UE (202), and
the PEI is available at the first network function prior to receiving the registration request from the UE (202).

15. The system (601) of claim 9, wherein:
the registration request is one of a periodic registration request, a mobility registration request, an initial registration request, and an emergency registration request, and
when the registration request is the initial registration request, the registration request includes a Permanent Equipment Identifier (PEI) associated with the UE (202).
